(19) United States
(12) Patent Application Publication
(10) Pub. No.: US 2006/0216579 A1
(43) Pub. Date: Sep. 28, 2006

(54) Rechargeable battery module

(76) Inventor: Kyu-Woong Cho, Suwon-si (KR)

Correspondence Address: CHRISTIE, PARKER & HALE, LLP, PO BOX 7068, PASADENA, CA, 91109-7068, US

(21) Appl. No.: 11/388,525

(22) Filed: Mar. 23, 2006

(30) Foreign Application Priority Data
Mar. 25, 2005 (KR) 10-2005-0024865

(51) Int. Cl. H01M 10/50

(52) U.S. Cl. 429/62

(57) ABSTRACT

A rechargeable battery module includes a plurality of unit cells and a unit cell housing adapted to channel a coolant. The housing has protrusions on an internal surface adapted to create turbulence in the coolant flow.

### CROSS-REFERENCE TO RELATED APPLICATION

This application claims priority to and the benefit of Korean Patent Application No. 10-2005-0024865 filed in the Korean Intellectual Property Office on Mar. 25, 2005, the entire content of which is incorporated herein by reference.

### BACKGROUND OF THE INVENTION

1. Field of the Invention

The present invention relates to a rechargeable battery. More particularly, the present invention relates to a rechargeable battery module which efficiently controls the temperature of unit cells.

2. Description of the Related Art

Unlike non-rechargeable batteries, rechargeable batteries can be repeatedly charged and discharged. Lower power batteries in which battery cells are made into a battery pack are used as the power source for various portable electronic devices such as cellular phones, laptop computers, and camcorders. Larger battery packs which are formed by connecting several to tens of the rechargeable battery cells may be suitable for motor driven devices such as hybrid electric vehicles.

Rechargeable batteries may be classified into different categories based on their external shape, for example, cylindrical and prismatic shapes.

A rechargeable battery module may be assembled by connecting rechargeable batteries together in series to be used for driving a motor of an electric vehicle that requires a large electrical power capacity.

The rechargeable battery module is typically composed of a plurality of rechargeable batteries (hereinafter, referred to as “unit cells” for convenience) connected in series.

Because the rechargeable battery module is constructed by interconnecting multiple unit cells, the heat generated at the respective unit cells needs to be dissipated. Particularly when a battery module is used to drive a motor for a hybrid electric vehicle (HEV), it is important to have adequate heat dissipation.

If heat is not dissipated properly, the heat generated from the unit cells may cause a temperature variation among the unit cells. The heat generated at the unit cells may also cause the temperature inside the unit cells to increase, resulting in an explosion.

Particularly, since a battery module for the HEV is charged and discharged by a high current, it may have deteriorated performance due to the heat generated by the internal reaction of a rechargeable battery.

### SUMMARY OF THE INVENTION

The present invention provides a rechargeable battery module including a plurality of unit cells and having maximized cooling efficiency. More specifically, an exemplary embodiment of the present invention provides a battery module with improved cooling efficiency by forming a coolant flow into a turbulent.

According to an embodiment of the present invention, a rechargeable battery module includes a plurality of unit cells and a unit cell housing to channel a coolant. The housing has internal protrusions contacting the coolant. The protrusions may be formed to project toward the unit cells in a predetermined pattern. The protrusions may be formed as a cylinder or a hemisphere.

Another embodiment of the present invention provides a rechargeable battery module which includes a plurality of unit cells and a unit cell housing to channel a coolant. The housing includes at least one internal corrugated wall. The corrugated wall may be formed as a circular arc or a triangle.

Yet another embodiment of the present invention provides a rechargeable battery module which includes a plurality of unit cells and a unit cell housing for channeling a coolant. A supportive plate with protrusions contacts the coolant and is located on the internal surface of the housing.

A method of improving cooling efficiency in unit cells in a rechargeable battery module is provided including providing a unit cell housing adapted to house the unit cells and to channel a coolant and locating a plurality of protrusions on an internal surface of the unit cell housing. The plurality of protrusions is adapted to create turbulence in a coolant channeled through the unit cell housing.

Additionally, a method of improving cooling efficiency in unit cells in a rechargeable battery module is provided including providing a unit cell housing adapted to house the unit cells and to channel a coolant and forming one or more inner walls of the unit housing having coolant deflecting perturbations. The coolant deflecting perturbations may be of a cylindrical or hemispherical shape.

### BRIEF DESCRIPTION OF THE DRAWINGS

FIG. 1 is a planer cross sectional view schematically illustrating the structure of rechargeable battery modules according to an embodiment of the present invention.

FIG. 2 is a perspective view schematically illustrating a housing of the rechargeable battery modules according to the embodiment of FIG. 1.

FIGS. 3, 4 and 5 are partial perspective views schematically illustrating housings of rechargeable battery modules according to other embodiments of the present invention.

FIG. 6 is a planer cross sectional view schematically illustrating rechargeable battery modules according to still another embodiment of the present invention.

FIGS. 7, 8 and 9 are a perspective view illustrating supportive plates according to still other embodiments of the present invention.

FIG. 10 is a planer cross sectional view schematically illustrating rechargeable battery modules according to still another embodiment of the present invention.

### DETAILED DESCRIPTION

According to the embodiments of the present invention, battery modules are described using air as a coolant. However, the present invention is not limited thereto and can include cold water or other liquids as a coolant.

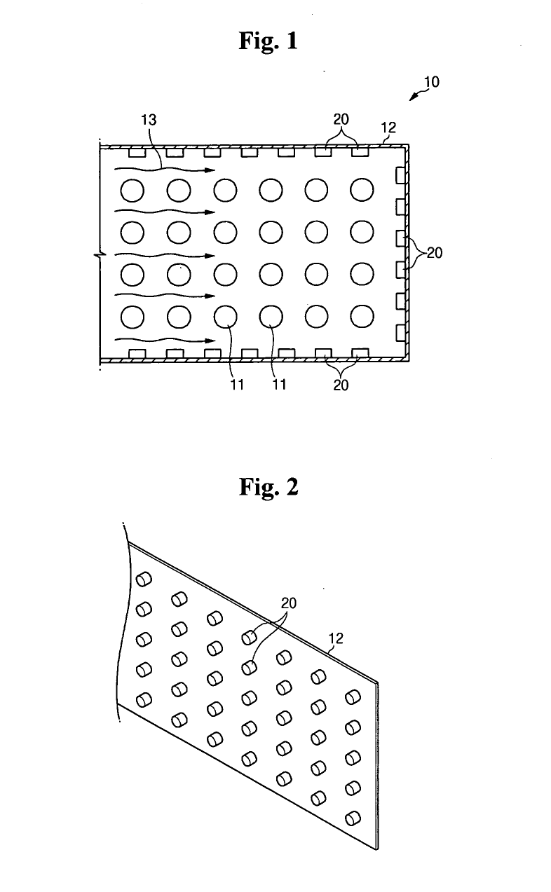

Referring to FIG. 1, a rechargeable battery module 10 includes a plurality of unit cells 11 which have an electrode assembly including positive and negative electrodes and a separator interposed therebetween and produce electricity, and a unit cell housing 12 through which air as a coolant internally flows.

The unit cells 11 may be formed as cylinders and disposed inside the housing 12 at a predetermined interval. However, the unit cells are not limited thereto and can be other shapes, such as a prism. The unit cells are shown schematically as individual cylinders, but in practice would be connected to provide a desired electricity production.

The housing 12 has an inlet (not shown) through which air 13 for controlling the temperature of the unit cell 11 can flow and an outlet (not shown) opposing the inlet, through which the air passing through the unit cell can be released.

The structure of the housing 12, the location of the inlet and outlet, and the disposition of the unit cells 11 in the housing 12 is not limited as described herein.

As air enters the housing 12, passes between the housing 12 and the unit cells 11, and flows out of the housing, the heat generated by the unit cells 11 can be transferred to the air and released out of the housing 12 with the air.

The housing 12 may have a plurality of protrusions 20 on its internal surfaces. The protrusions 20 serve to create turbulence in the air flow when air enters the housing 12 and passes through the unit cells 11, facilitating the air to be evenly diffused into the unit cells 11. Therefore, the protrusions 20 may prevent thermal imbalance that can occur in the battery module 10.

The protrusions 20 may be formed on any internal surface of the housing, such as a side, a bottom, or a top. In other words, the protrusions 20 can be formed on any side of the housing as long as it contacts the coolant air.

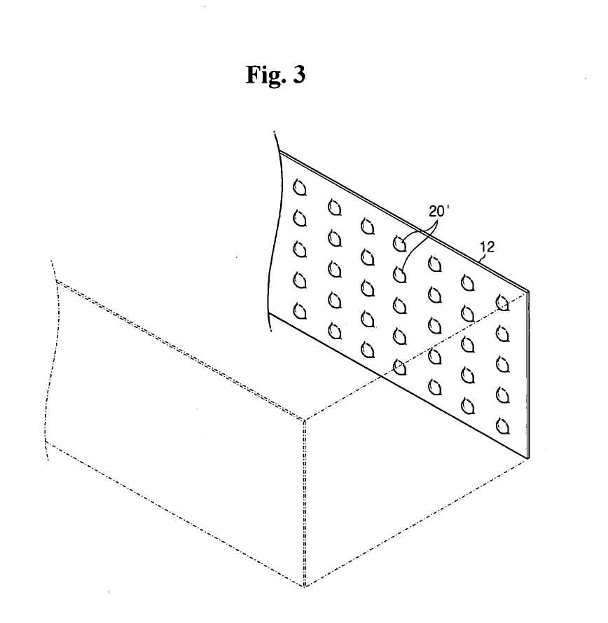

Referring now to FIG. 2, the protrusions 20 are formed on one side of the housing 12. The protrusions 20 have a cylindrical shape. However, they are not limited thereto, and may also be, for example, a hemisphere, (FIG. 3) a cone, a quadrangular prism, a polygonal pyramid, or a conical shape with a cutaway apex area that is wide at the top and narrow at the bottom. In addition, the protrusions 20 have a height that is capable of being regulated, depending on the design of a rechargeable battery module 10 such as the quantity, size and locations of the unit cells.

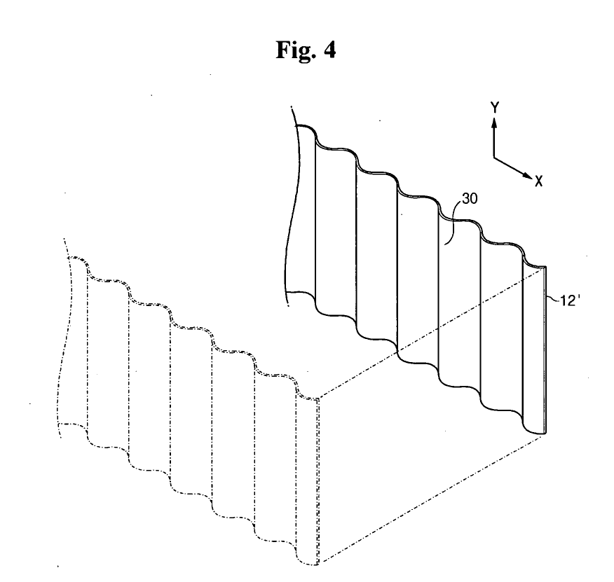

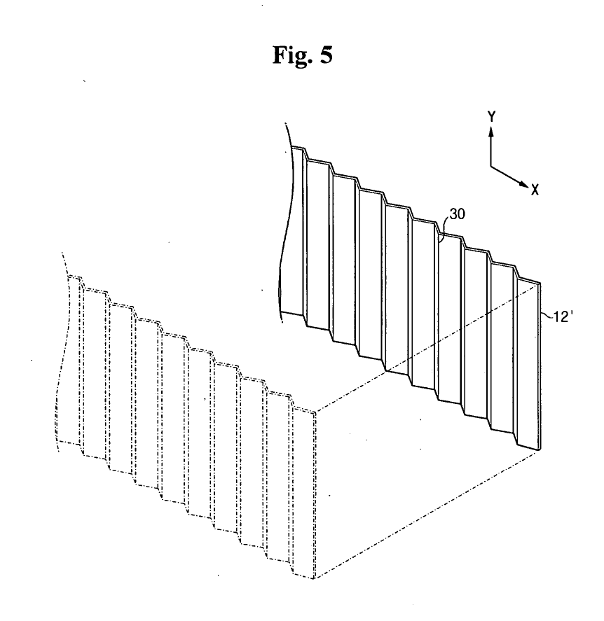

FIG. 4 is a schematic view illustrating a housing 12′ of a rechargeable battery module according to another embodiment of the present invention wherein the housing is formed of a plate with a corrugated portion 30. The corrugated portion 30 may also be shaped, for example, as an arc or a triangle (FIG. 5). Furthermore, there is no particular limit to the number of the corrugated portions 30 formed on one side of the housing 12′ or their (regular or irregular) pattern.

When a rechargeable battery module includes a housing 12′ with corrugated portions 30, the corrugated portions 30 create turbulence in coolant air entering and passing through the housing. Accordingly, coolant air may be evenly diffused among the unit cells, improving entire cooling efficiency of the unit cells. In one exemplary embodiment, the corrugated portions 30 (Y direction) are perpendicularly disposed to air flow (X direction).

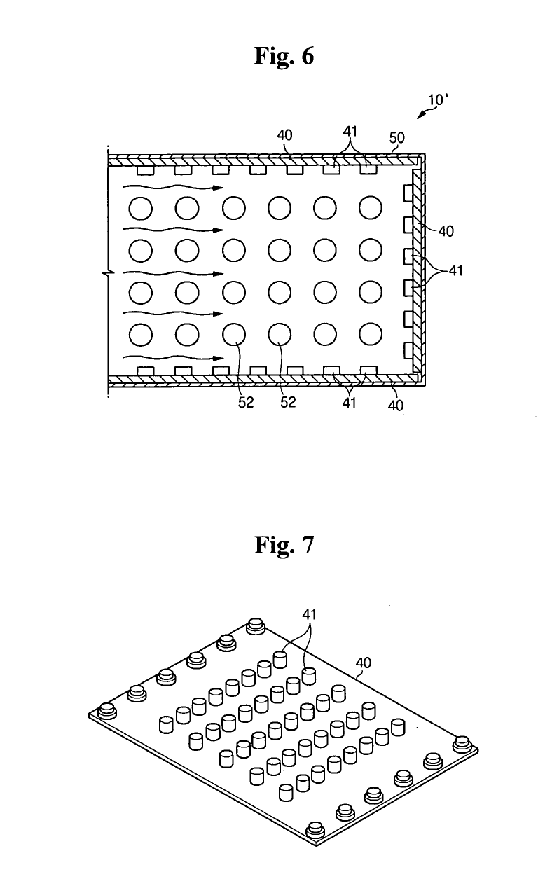

FIG. 6 is a schematic view illustrating a rechargeable battery module 10′ according to still another embodiment of the present invention. A rechargeable battery module 10′ is formed by disposing a plurality of unit cells 52 in a housing 50 in a predetermined pattern much like that of FIG. 1. Additionally, a supportive plate 40 with protrusions 41 formed at a predetermined interval is attached to the inside of the housing 50. The supportive plate 40 may be formed of the same material as the housing 50 and may be attached to any internal surface of the housing 50. In one exemplary embodiment, a supportive plate 40 is attached to every side of the housing 50 which contacts coolant air, and the supportive plate is attached to the sides through attaching method like welding, riveting, combining by a screw and a nut, and the like.

FIG. 7 is a perspective view particularly illustrating the supportive plate 40 with the protrusions 41. The protrusions may be formed in various shapes including, for example, a cylinder.

The height of the protrusions 41 may be adapted to the design of a rechargeable battery module 10′ to maximize cooling efficiency.

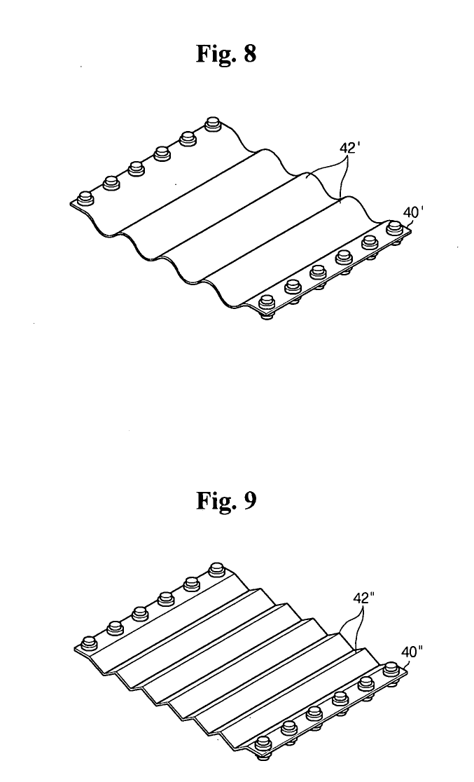

FIGS. 8 and 9 are perspective views illustrating exemplary supportive plates 40′, 40″ according to other embodiments of the present invention. The supportive plates are attached to the internal surface of the housing as described above.

Referring to FIGS. 8 and 9, the supportive plates 40′, 40″ are formed of the same shape as the housing in FIGS. 4 and 5 and have corrugated portions 42′ and 42″ formed as, for example, an arc and a triangle.

In other words, the supportive plates 40, 40′, and 40″ have the same structure and function as the housing as described above, but are formed separately from the housing 50 and attached thereto.

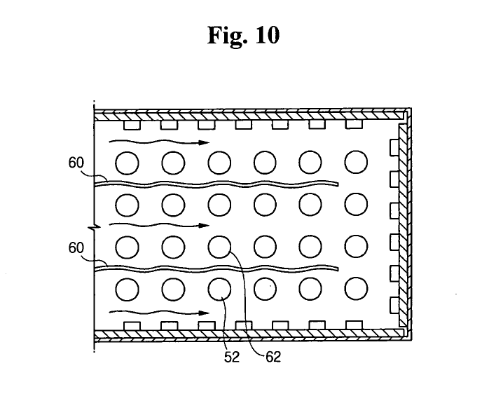

FIG. 10 shows that a corrugated plate 60 may be interposed between unit cells 62.

According to the present invention, a rechargeable battery has improved cooling efficiency in unit cells by adapting the structure of a housing to change the flow of a coolant passing through the rechargeable battery.

In addition, as the coolant is diffused among the unit cells, the rechargeable battery module can have a thermal balance.

The rechargeable battery module may be usefully applied to electric machines driven by a motor requiring a high power characteristic such as a hybrid electric vehicle (HEV), an electric vehicle (EV), a cordless cleaner, a motorbike, and an electric scooter. While this invention has been described in connection with exemplary embodiments, it is to be understood that the invention is not limited to the disclosed embodiments, but, is intended to cover various modifications and equivalent arrangements included within the spirit and scope of the appended claims.

What is claimed is:

1. A rechargeable battery module comprising:
a plurality of unit cells; and
a unit cell housing adapted to house the plurality of unit cells and to channel a coolant;
wherein protrusions adapted to contact the coolant are formed on an internal surface of the housing.

2. The rechargeable battery module of claim 1, wherein the protrusions project toward the plurality of unit cells in a predetermined pattern.

3. The rechargeable battery module of claim 1, wherein the protrusions have a cylindrical or hemispheric shape.

4. The rechargeable battery module of claim 1, wherein the coolant is air.

5. A rechargeable battery module comprising:
a plurality of unit cells; and
a unit cell housing adapted to house the plurality of unit cells and to channel a coolant;
wherein the housing includes at least one internal corrugated wall.

6. The rechargeable battery module of claim 5, wherein the at least one internal corrugated wall is formed as arched corrugations or triangular corrugations.

7. A rechargeable battery module comprising:
a plurality of unit cells; and
a unit cell housing and adapted to channel a coolant;
wherein a supportive plate having protrusions adapted to contact the coolant is mounted on an internal surface of the housing.

8. The rechargeable battery module of claim 7, wherein the protrusions project toward the plurality of unit cells in a predetermined pattern.

9. The rechargeable battery module of claim 7, wherein the protrusions are cylindrical.

10. The rechargeable battery module of claim.7, wherein a supportive plate with corrugated portions is located between the plurality of unit cells.

11. A rechargeable battery module comprising:
a plurality of unit cells; and
a unit cell housing adapted to house the plurality of unit cells and to channel a coolant;
wherein a supportive plate with corrugated portions is mounted on an internal surface of the housing.

12. The rechargeable battery module of claim 11, wherein the corrugated portions are formed as an arc or a triangular shape.

13. A method of improving cooling efficiency in unit cells in a rechargeable battery module comprising:
providing a unit cell housing adapted to house the unit cells and to channel a coolant; and
locating a plurality of protrusions on an internal surface of the unit cell housing, the plurality of protrusions being adapted to create turbulence in a coolant channeled through the unit cell housing.

14. The method of claim 13, wherein the plurality of protrusions have a cylindrical or hemispheric shape.

15. The method of claim 13, wherein the coolant is air.

16. A method of improving cooling efficiency in unit cells in a rechargeable battery module comprising:
providing a unit cell housing adapted to house the unit cells and to channel a coolant; and
forming one or more inner walls of the unit housing having coolant deflecting perturbations;
wherein the coolant deflecting perturbations are of a cylindrical or hemispherical shape.

17. The method of claim 16, wherein the coolant deflecting perturbations are formed by a corrugated plate located on an internal surface of the unit cell housing.

18. The method of claim 16, wherein the coolant is air.
